(19) United States
(12) Patent Application Publication
(10) Pub. No.: US 2025/0355259 A1
(43) Pub. Date: Nov. 20, 2025

(54) Waveguide Lens

(71) Applicant: SUNNY OMNILIGHT NANOOPTICS INFORMATION TECHNOLOGY CO., LTD., Shanghai (CN)

(72) Inventors: Qian GE, Shanghai (CN); Shun LAN, Shanghai (CN); Jie WANG, Shanghai (CN); Jian SHEN, Shanghai (CN)

(21) Appl. No.: 18/871,792

(22) PCT Filed: Mar. 4, 2024
(86) PCT No.: PCT/CN2024/079969

§ 371 Date: Dec. 4, 2024

(30) Foreign Application Priority Data
Mar. 16, 2023 (CN) 202320521586.0

(51) Int. Cl. G02B 27/01; G02C 7/02

(52) U.S. Cl. CPC G02B 27/0176; G02B 27/0172; G02C 7/02; G02B 2027/0152; G02B 2027/0169; G02B 2027/0178; G02B 2027/0194; G02C 2202/16; G02C 2202/20

(57) ABSTRACT

A waveguide lens, including: a waveguide substrate, wherein a diffraction grating is provided on a side surface of the waveguide substrate; a filling layer, wherein the filling layer is provided in a filling manner on a side of the diffraction grating that is away from the waveguide substrate; a low-refractive-index transparent layer, wherein the low-refractive-index transparent layer is connected with the filling layer; a first glass cover plate, wherein the first glass cover plate is bonded to a side surface of the low-refractive-index transparent layer that is away from the waveguide substrate; and a second glass cover plate, wherein the second glass cover plate is bonded to another side surface of the waveguide substrate. The problem of it being difficult to simultaneously take lightweight and imaging stability of a waveguide lens in the prior art into consideration is solved.

### CROSS-REFERENCE TO RELATED APPLICATIONS

The disclosure claims the priority of Chinese Patent Application 2023205215860, filed in the State Intellectual Property Office of China on Mar. 16, 2023, and entitled “Waveguide Lens”, and claims the priority to PCT Application No. PCT/CN2024/079969, filed to the China National Intellectual Property Administration on Mar. 4, 2024 and entitled “Waveguide Lens”, the disclosures of which are hereby incorporated by reference in its entirety.

### TECHNICAL FIELD

The disclosure relates to the technical field of optical display devices, and particularly relates to a waveguide lens.

### BACKGROUND

With regard to a waveguide lens, a piece of high-refractive-index glass is mainly used as a waveguide substrate, a diffraction grating is provided on the substrate, meanwhile, in order to protect the diffraction grating, a glass cover plate is usually provided on the diffraction grating, the glass cover plate is bonded to the waveguide substrate by an optical cement, so the glass cover plate is able to avoid pollution damages of external impurities and particles to the diffraction grating. Currently, the glass cover plate commonly used has a thickness of about 0.4 mm, when the thickness of the glass cover plate is further reduced, the glass cover plate is prone to deformation under a pressure during a bonding process with the waveguide substrate, and since the waveguide substrate and the glass cover plate are usually bonded by using OCA/OCR glue with a thickness of 0.05 mm, when the glass cover plate deforms, the diffraction grating on the surface of the waveguide substrate is damaged, thereby affecting the imaging performance of the waveguide lens.

In addition, in order to avoid the damage to the total reflection transmission of rays inside the waveguide lens by pollution such as fingerprints and dirt on a non-grating surface of the waveguide lens, a layer of glass cover plate is usually added on the non-grating surface of the waveguide lens for protection. Therefore, a thickness of the waveguide lens added with two layers of glass cover plates is about 1.7 mm, which is relatively thick for consumption-level lightweight AR waveguide glasses, and if a weight of myopia lenses is also taken into consideration when a myopia user users the AR waveguide glasses, a weight of the whole product is relatively heavy, so that the myopia user experience is poor.

In other words, the waveguide lens in the prior art has a problem of it being difficult to simultaneously take lightweight and imaging stability into consideration.

### SUMMARY

Some embodiments of the disclosure provide a waveguide lens to solve the problem of it being difficult to simultaneously take lightweight and imaging stability of a waveguide lens in the prior art into consideration.

In order to achieve the above object, an embodiment of the disclosure provides a waveguide lens, including: a waveguide substrate, wherein a diffraction grating is provided on a side surface of the waveguide substrate; a filling layer, wherein the filling layer is provided in a filling manner on the side of the diffraction grating that is away from the waveguide substrate, and the side surface of the waveguide substrate is completely covered by the filling layer; a low-refractive-index transparent layer, wherein the low-refractive-index transparent layer is connected with the filling layer and is located on a side of the filling layer that is away from the waveguide substrate; a first glass cover plate, wherein the first glass cover plate is bonded to the side surface of the low-refractive-index transparent layer that is away from the waveguide substrate; and a second glass cover plate, wherein the second glass cover plate is bonded to another side surface of the waveguide substrate.

In an embodiment mode, the other side surface of the waveguide substrate is also provided with the diffraction grating, the diffraction grating, the filling layer and the low-refractive-index transparent layer are further sequentially included between the another side surface of the waveguide substrate and the second glass cover plate.

In an embodiment mode, the waveguide lens further includes a first bonding layer and a second bonding layer, the first glass cover plate is bonded to the side surface of the low-refractive-index transparent layer that is away from the waveguide substrate by the first bonding layer, and the second glass cover plate is bonded to the other side surface of the waveguide substrate by the second bonding layer.

In an embodiment mode, the thickness of the first glass cover plate and the thickness of the second glass cover plate are both less than or equal to 0.1 mm.

In an embodiment mode, the thickness of the first glass cover plate and the thickness of the second glass cover plate are both greater than or equal to 0.02 mm.

In an embodiment mode, the height of the filling layer is greater than the height of the diffraction grating, and a side surface of the filling layer that is away from the waveguide substrate is a plane.

In an embodiment mode, the refractive index of the diffraction grating is greater than the refractive index of the filling layer, and the refractive index of the diffraction grating is greater than the refractive index of the low-refractive-index transparent layer.

In an embodiment mode, the refractive index of the low-refractive-index transparent layer is less than the refractive index of the filling layer.

In an embodiment mode, the refractive index of the filling layer is greater than or equal to 1.0 and less than or equal to 1.4; and/or the refractive index of the low-refractive-index transparent layer is less than or equal to 1.3, and the viscosity of the low-refractive-index transparent layer is greater than or equal to 2000 mPa·s.

In an embodiment mode, the refractive index of the waveguide substrate is greater than or equal to 1.5 and less than or equal to 4; and/or the thickness of the waveguide substrate is greater than or equal to 0.2 mm and less than or equal to 2 mm.

In an embodiment mode, at least one of the first glass cover plate and the second glass cover plate is a myopia lens.

By applying the technical solution of the disclosure, the waveguide lens includes the waveguide substrate, the filling layer, the low-refractive-index transparent layer, the first glass cover plate and the second glass cover plate, wherein the diffraction grating is provided on the side surface of the waveguide substrate; the filling layer is provided in the filling manner on the side of the diffraction grating that is away from the waveguide substrate, and the side surface of the waveguide substrate is completely covered by the filling layer; the low-refractive-index transparent layer is connected with the filling layer and is located on the side of the filling layer that is away from the waveguide substrate; the first glass cover plate is bonded to the side surface of the low-refractive-index transparent layer that is away from the waveguide substrate; and the second glass cover plate is bonded to the other side surface of the waveguide substrate.

The filling layer is provided in the filling manner on the side of the diffraction grating that is away from the waveguide substrate, and the side surface of the waveguide substrate is completely covered by the filling layer, in this way, the filling layer is able to completely cover the diffraction grating and completely cover the side surface of the waveguide substrate, so that the filling layer is able to protect the diffraction grating, thereby avoiding the risk that the diffraction grating is damaged by an external force, and facilitating effective diffraction of the diffraction grating, thus ensuring the stability of the imaging performance of the waveguide lens. Since the low-refractive-index transparent layer is connected with the filling layer and is located on the side of the filling layer that is away from the waveguide substrate, the low-refractive-index transparent layer is equivalent to a transparent air layer to provide a condition for rays to participate in total reflection of the waveguide lens. By providing the filling layer and the low-refractive-index transparent layer on a side of the waveguide substrate having the diffraction grating, there is no air between the diffraction grating and the first glass cover plate, therefore in the case of temperature return after a high temperature, no mist is generated inside the waveguide lens, so that the reliability is good; meanwhile, the filling layer and the low-refractive-index transparent layer fill an original air gap between the diffraction grating and the first glass cover plate, thereby reducing the risk that the first glass cover plate is pressed and deformed to extrude and damage the diffraction grating; and in addition, the filling layer and the low-refractive-index transparent layer is also able to replace a part of the first glass cover plate, thereby reducing the thickness of the first glass cover plate, thus reducing an overall weight of waveguide glasses to achieve lightweight. By bonding the second glass cover plate to the other side surface of the waveguide substrate, the second glass cover plate protects a non-grating surface of the waveguide lens, thereby preventing external dirt from being attached to the other side surface of the waveguide substrate to affect the stable transmission of the rays in the waveguide substrate. On the premise of ensuring the diffraction waveguide performance, the waveguide lens of the disclosure uses a lighter and thinner glass cover plate, thereby further reducing the thickness and weight of the waveguide lens to achieve lightweight.

### BRIEF DESCRIPTION OF THE DRAWINGS

The drawings, which constitute a part of the disclosure, are used to provide a further understanding of the disclosure, and schematic embodiments of the disclosure and descriptions thereof are used to explain the disclosure, and do not constitute an improper limitation on the disclosure. In the drawings:

FIG. 1 illustrates a schematic structural diagram of a waveguide lens according to an embodiment of the disclosure; and

FIG. 2 illustrates an exploded view of the waveguide lens in FIG. 1.

The above drawings include the following reference signs:
10. waveguide substrate; 11. diffraction grating; 20. filling layer; 30. low-refractive-index transparent layer; 40. first bonding layer; 50. first glass cover plate; 60. second bonding layer; 70. second glass cover plate.

### DETAILED DESCRIPTION OF THE EMBODIMENTS

In order to solve the problem of it being difficult to simultaneously take lightweight and imaging stability of a waveguide lens in the prior art into consideration, the disclosure provides a waveguide lens.

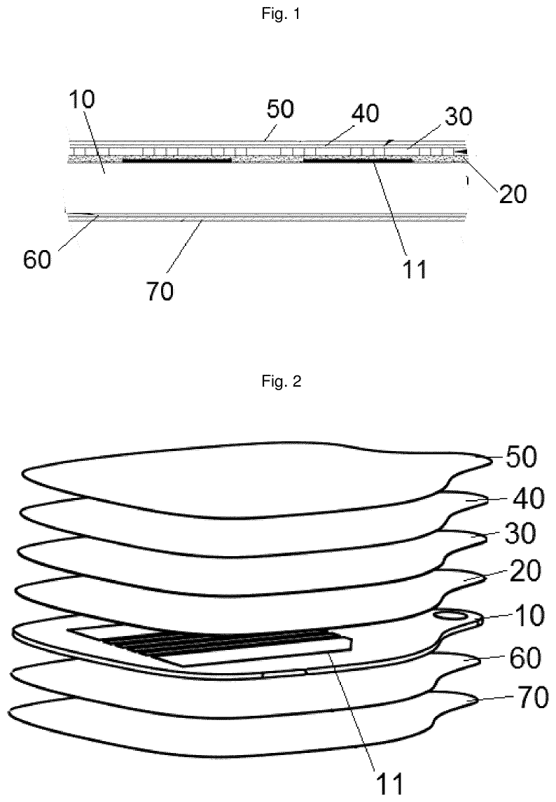

As shown in FIG. 1 and FIG. 2, the waveguide lens includes a waveguide substrate 10, a filling layer 20, a low-refractive-index transparent layer 30, a first glass cover plate 50 and a second glass cover plate 70, wherein a diffraction grating 11 is provided on a side surface of the waveguide substrate 10; the filling layer 20 is provided in a filling manner on a side of the diffraction grating 11 that is away from the waveguide substrate 10, and the side surface of the waveguide substrate 10 is completely covered by the filling layer 20; the low-refractive-index transparent layer 30 is connected with the filling layer 20 and is located on the side of the filling layer 20 that is away from the waveguide substrate 10; the first glass cover plate 50 is bonded to the side surface of the low-refractive-index transparent layer 30 that is away from the waveguide substrate 10; and the second glass cover plate 70 is bonded to the other side surface of the waveguide substrate 10.

The filling layer 20 is provided in the filling manner on the side of the diffraction grating 11 that is away from the waveguide substrate 10, and a side surface of the waveguide substrate 10 is completely covered by the filling layer 20, in this way, the filling layer 20 is able to completely cover the diffraction grating 11 and completely cover a side surface of the waveguide substrate 10, so that the filling layer 20 is able to protect the diffraction grating 11, thereby avoiding the risk that the diffraction grating 11 is damaged by an external force, and facilitating effective diffraction of the diffraction grating 11, thus ensuring the stability of the imaging performance of the waveguide lens. Since the low-refractive-index transparent layer 30 is connected with the filling layer 20 and is located on the side of the filling layer 20 that is away from the waveguide substrate 10, the low-refractive-index transparent layer 30 is equivalent to a transparent air layer to provide a condition for rays to participate in total reflection of the waveguide lens. By providing the filling layer 20 and the low-refractive-index transparent layer 30 on a side of the waveguide substrate 10 having the diffraction grating 11, there is no air between the diffraction grating 11 and the first glass cover plate 50, therefore in the case of temperature return after a high temperature, no mist is generated inside the waveguide lens, so that the reliability is good; meanwhile, the filling layer 20 and the low-refractive-index transparent layer 30 fill an original air gap between the diffraction grating 11 and the first glass cover plate 50, thereby reducing the risk that the first glass cover plate 50 is pressed and deformed to extrude and damage the diffraction grating 11; and in addition, the filling layer 20 and the low-refractive-index transparent layer 30 is also able to replace a part of the first glass cover plate 50, thereby reducing the thickness of the first glass cover plate 50, thus reducing an overall weight of waveguide glasses to achieve lightweight. By bonding the second glass cover plate 70 to the other side surface of the waveguide substrate 10, the second glass cover plate 70 protects a non-grating surface of the waveguide lens, thereby preventing external dirt from being attached to the other side surface of the waveguide substrate 10 to affect the stable transmission of the rays in the waveguide substrate 10. On the premise of ensuring the diffraction waveguide performance, the waveguide lens of the disclosure uses a lighter and thinner glass cover plate, thereby further reducing the thickness and weight of the waveguide lens to achieve lightweight.

In an embodiment, the waveguide lens further includes a first bonding layer 40 and a second bonding layer 60, the first glass cover plate 50 is bonded to the side surface of the low-refractive-index transparent layer 30 that is away from the waveguide substrate 10 by the first bonding layer 40, and the second glass cover plate 70 is bonded to the another side surface of the waveguide substrate 10 by the second bonding layer 60. In this way, it is beneficial to increasing the bonding strength between the first glass cover plate 50 and the low-refractive-index transparent layer 30, and the bonding strength between the second glass cover plate 70 and the waveguide substrate 10, thereby ensuring the overall connection stability.

It should be noted that the first bonding layer 40 is made of one of an ultraviolet curing optical cement or a solid optical cement, and the second bonding layer 60 is made of one of the ultraviolet curing optical cement or the solid optical cement. In this way, it is beneficial to ensuring a bonding effect of the first bonding layer 40 and the second bonding layer 60, thereby ensuring the overall overlapping strength of the waveguide lens. In an embodiment of the disclosure, the first bonding layer 40 and the second bonding layer 60 are both made of the ultraviolet curing optical cement.

In an embodiment shown in FIG. 1 and FIG. 2, the waveguide lens of the disclosure is of a structure in which a single surface of the waveguide substrate 10 is provided with the diffraction grating 11. However, in an embodiment not shown in the disclosure, the waveguide lens of the disclosure is of a structure in which double surfaces of the waveguide substrate 10 are provided with diffraction gratings 11, at this time, the side surface and the other side surface of the waveguide substrate 10 are both provided with diffraction gratings 11, and the diffraction gratings 11, an another filling layer 20 and an another low-refractive-index transparent layer 30 are further sequentially included between the other side surface of the waveguide substrate 10 and the second glass cover plate 70. That is, both sides of the waveguide substrate 10 are provided with diffraction gratings 11, filling layers 20 and low-refractive-index transparent layers 30, so that the structures on the both sides of the waveguide substrate 10 are symmetrical with respect to the waveguide substrate 10, and this embodiment is another embodiment different from that in FIG. 1 and FIG. 2. That is, both the waveguide lens provided with the diffraction grating 11 on the single surface of the waveguide substrate 10 shown in FIG. 1 and the waveguide lens provided with the diffraction gratings 11 on double surfaces of the waveguide substrate 10 in this embodiment are able to applied to AR glasses, and a selection of embodiments depends on which structure is finally selected in the actual waveguide design and process.

In an embodiment, the thickness of the first glass cover plate 50 is greater than or equal to 0.02 mm and less than or equal to 0.1 mm. By constraining the thickness of the first glass cover plate 50 to be greater than or equal to 0.02 mm, it is beneficial to ensuring that the first glass cover plate 50 has sufficient strength, thereby avoiding the risk that the first glass cover plate 50 is too thin and thus is prone to damage; meanwhile, by constraining the thickness of the first glass cover plate 50 to be less than or equal to 0.1 mm, the thickness of the first glass cover plate 50 is reasonably compressed to realize the lightweight and thinness of the first glass cover plate 50 on the premise of ensuring the structural strength, thereby reducing the weight of the waveguide lens. The purpose of providing the first glass cover plate 50 is to protect the diffraction grating 11 together with the filling layer 20 and the low-refractive-index transparent layer 30; and the filling layer 20 and the low-refractive-index transparent layer 30 between the first glass cover plate 50 and the diffraction grating 11 play a role in buffering the external force, so it is not necessary to provide a glass cover plate with a relatively large thickness of 0.4 mm as in the prior art.

In an embodiment, the thickness of the second glass cover plate 70 is greater than or equal to 0.02 mm and less than or equal to 0.1 mm. By constraining the thickness of the second glass cover plate 70 between 0.02 mm and 0.1 mm, the thickness of the second glass cover plate 70 is reasonably compressed on the premise of ensuring the structural strength of the second glass cover plate 70, so as to realize the lightweight and thinness of the second glass cover plate 70, thereby realizing the lightweight of the waveguide lens. The purpose of providing the second glass cover plate 70 is to prevent fingerprints or particles from being attached to the other side surface of the waveguide substrate 10 to affect the total reflection propagation inside the waveguide substrate 10, thereby ensuring the imaging quality of the waveguide lens.

It should be noted that the first glass cover plate 50 is made of tempered glass or resin, and the second glass cover plate 70 is made of tempered glass or resin. In an embodiment of the disclosure, the first glass cover plate 50 is made of tempered glass and has a thickness of 0.05 mm; and the second glass cover plate 70 is made of tempered glass and has a thickness of 0.05 mm.

As shown in FIG. 1, the height of the filling layer 20 is greater than the height of the diffraction grating 11, and the side surface of the filling layer 20 that is away from the waveguide substrate 10 is a plane. In this way, the side of the filling layer 20 that is away from the waveguide substrate 10 is higher than the diffraction grating 11, thereby ensuring that the filling layer 20 is able to completely cover the exposed part of the diffraction grating 11, thus protecting the diffraction grating 11 and ensuring the use reliability and stability of the diffraction grating 11.

In an embodiment, the filling layer 20 is made of a uniformly distributed low-refractive-index material, and the refractive index of the filling layer 20 is greater than or equal to 1.0 and less than or equal to 1.4. In an embodiment of the disclosure, the refractive index of the filling layer 20 is 1.33, and the thickness thereof is 1 μm. The purpose of the filling layer 20 is to fill a gap between the diffraction gratings 11 to provide a medium condition for the diffraction of the diffraction gratings 11. Due to an existence of hollow particles in some ultra-low-refractive-index materials, when these ultra-low-refractive-index materials directly cover a surface of the diffraction grating 11, the hollow particles in the ultra-low-refractive-index materials may fall into micro-structures of the diffraction grating 11, thus causing unnecessary scattering to affect the imaging of the waveguide lens. By covering the surface of the diffraction grating 11 with a layer of uniformly distributed filling layer 20, and covering the filling layer 20 with the low-refractive-index transparent layer 30, the influence of the hollow particles in the ultra-low-refractive-index materials on the micro-structures of the diffraction grating 11 may be effectively avoided.

In an embodiment, the refractive index of the diffraction grating 11 is greater than the refractive index of the filling layer 20, the refractive index of the diffraction grating 11 is greater than the refractive index of the low-refractive-index transparent layer 30, and the filling layer 20 and the low-refractive-index transparent layer 30 are made of different materials. In this way, it is beneficial to ensuring stable diffraction transmission of the rays by the diffraction grating 11, so that the filling layer 20 and the low-refractive-index transparent layer 30 do not affect the transmission of the rays.

In an embodiment, the refractive index of the low-refractive-index transparent layer 30 is less than the refractive index of the filling layer 20. However, the refractive indexes of the materials of the low-refractive-index transparent layer 30 and the filling layer 20 are both in the range of a low refractive index. The low-refractive-index transparent layer 30 is made of a low-refractive-index optically transparent bonding inorganic material, the refractive index of a conventional binder is 1.4, a binder of which the refractive index is close to that of air is used for filling in the embodiment, the refractive index of the low-refractive-index transparent layer 30 is less than or equal to 1.3, in an embodiment of the disclosure, the refractive index of the low-refractive-index transparent layer 30 is 1.3, which is used for bonding and meeting a total reflection condition inside the waveguide lens, and since the rays are transmitted inside the waveguide lens, a light efficiency loss may be ignored; and the thickness of the low-refractive-index transparent layer 30 is 5 μm, the viscosity of the low-refractive-index transparent layer 30 is greater than or equal to 2000 mPa·s, therefore by using the low-refractive-index transparent layer 30 for filling and bonding, on one hand, total reflection of the rays inside the waveguide substrate 10 is able to be well achieved to reduce the light efficiency loss, and on the other hand, the bonding area is increased to ensure the overlapping strength.

In an embodiment, the waveguide substrate 10 is a transparent substrate and is composed of a high-refractive-index glass material, which meets an internal total reflection condition of the rays under certain angle and medium conditions, and according to design requirements, the refractive index of the waveguide substrate 10 is greater than or equal to 1.5 and less than or equal to 4; and the thickness of the waveguide substrate 10 is greater than or equal to 0.2 mm and less than or equal to 2 mm. In an embodiment of the disclosure, the refractive index of the waveguide substrate 10 is 2.0, but in other embodiments, the refractive index of the waveguide substrate 10 is able to be 1.8, 1.9, and the like, and the thickness of the waveguide substrate 10 is 0.6 mm.

It should be noted that the diffraction grating 11 at least includes a coupling-in grating for coupling in rays and a coupling-out grating for coupling out rays, and certainly may further include a turning grating, when the diffraction grating includes the turning grating, the coupling-in grating couples the rays of an external optical machine into the waveguide substrate 10, and the turning grating receives the rays transmitted from the coupling-in grating and then performs pupil-expansion transmission, and the coupling-out grating couples outs the pupil-expansion rays, which are transmitted from the turning grating, to human eyes for display. The refractive index of the diffraction grating 11 is greater than or equal to 1.5 and less than or equal to 2.1, in an embodiment of the disclosure, the refractive index of the diffraction grating 11 is 1.91, but in other alternative embodiments, the refractive index of the diffraction grating 11 is able to be 1.5, 1.6, 1.7, 1.8, 1.9, 2.0, 2.1, and the like, and the refractive index of the diffraction grating 11 is close to the refractive index of the waveguide substrate 10.

In another embodiment, at least one of the first glass cover plate 50 and the second glass cover plate 70 is a myopia lens. That is, the first glass cover plate 50 and the second glass cover plate 70 is able to be replaced with myopia lenses, the first bonding layer 40, the second bonding layer 60 are in full contact with the surfaces of the first glass cover plate 50 and the second glass cover plate 70, and the first bonding layer 40 and the second bonding layer 60 are made of a flowing bonding material, therefore the first glass cover plate 50 or the second glass cover plate 70 is able to be replaced with the myopia lens to meet the use requirements of myopia users, and meanwhile, the refractive performance of the myopia lens is also able to be used to enable the waveguide lens to perform imaging within a limited distance (the waveguide lens usually performs imaging at an infinite distance), thereby meeting the use requirements of users in specific scenarios such as object recognition and gesture recognition.

From the above description, it is able to be seen that the above embodiments of the disclosure achieve the following technical effects:
1. By adding the filling layer 20 and the low-refractive-index transparent layer 30, the filling layer 20 and the low-refractive-index transparent layer 30 are able to replace a part of the first glass cover plate 50 to protect the diffraction grating 11, so that the filling layer 20 and the low-refractive-index transparent layer 30 are able to play a role in buffering the external force, thereby ensuring the performance stability of the diffraction grating 11, and meanwhile, it is beneficial to compressing the thickness of the first glass cover plate 50 and the thickness of the second glass cover plate 70 to compress the overall thickness of the waveguide lens, thereby reducing the weight of the waveguide lens to realize lightweight;
2. the waveguide lens of the disclosure prevents the influence of mist, dust and the like on the waveguide lens itself, thereby improving the waveguide reliability; and
3. the myopia lens is able to replace the first glass cover plate 50 or the second glass cover plate 70, thereby adapting to the myopia users without additionally increasing the weight of the waveguide lens.

The foregoing descriptions are merely preferred embodiments of the disclosure and are not intended to limit the disclosure, and for those skilled in the art, the disclosure may have various changes and variations. Any modifications, equivalent replacements, improvements and the like, made within the spirit and principles of the disclosure, shall fall within the protection scope of the disclosure.

What is claimed is:

1. A waveguide lens, comprising:
a waveguide substrate, wherein a diffraction grating is provided on a side surface of the waveguide substrate;
a filling layer, wherein the filling layer is provided in a filling manner on a side of the diffraction grating that is away from the waveguide substrate, and the side surface of the waveguide substrate is completely covered by the filling layer;
a low-refractive-index transparent layer, wherein the low-refractive-index transparent layer is connected with the filling layer and is located on a side of the filling layer that is away from the waveguide substrate;
a first glass cover plate, wherein the first glass cover plate is bonded to a side surface of the low-refractive-index transparent layer that is away from the waveguide substrate; and
a second glass cover plate, wherein the second glass cover plate is bonded to another side surface of the waveguide substrate.

2. The waveguide lens according to claim 1, wherein the other side surface of the waveguide substrate is also provided with the diffraction grating, the diffraction grating, the filling layer and the low-refractive-index transparent layer are further sequentially comprised between the another side surface of the waveguide substrate and the second glass cover plate.

3. The waveguide lens according to claim 1, wherein the waveguide lens further comprises a first bonding layer and a second bonding layer, the first glass cover plate is bonded to the side surface of the low-refractive-index transparent layer that is away from the waveguide substrate by the first bonding layer, and the second glass cover plate is bonded to the other side surface of the waveguide substrate by the second bonding layer.

4. The waveguide lens according to claim 1, wherein a thickness of the first glass cover plate and a thickness of the second glass cover plate are both less than or equal to 0.1 mm.

5. The waveguide lens according to claim 1, wherein a thickness of the first glass cover plate and a thickness of the second glass cover plate are both greater than or equal to 0.02 mm.

6. The waveguide lens according to claim 1, wherein a height of the filling layer is greater than a height of the diffraction grating, and a side surface of the filling layer that is away from the waveguide substrate is a plane.

7. The waveguide lens according to claim 1, wherein a refractive index of the diffraction grating is greater than a refractive index of the filling layer, and the refractive index of the diffraction grating is greater than a refractive index of the low-refractive-index transparent layer.

8. The waveguide lens according to claim 1, wherein a refractive index of the low-refractive-index transparent layer is less than a refractive index of the filling layer.

9. The waveguide lens according to claim 1, wherein,
a refractive index of the filling layer is greater than or equal to 1.0 and less than or equal to 1.4; and/or
a refractive index of the low-refractive-index transparent layer is less than or equal to 1.3, and a viscosity of the low-refractive-index transparent layer is greater than or equal to 2000 mPa·s.

10. The waveguide lens according to claim 1, wherein,
a refractive index of the waveguide substrate is greater than or equal to 1.5 and less than or equal to 4; and/or
a thickness of the waveguide substrate is greater than or equal to 0.2 mm and less than or equal to 2 mm.

11. The waveguide lens according to claim 1, wherein at least one of the first glass cover plate and the second glass cover plate is a myopia lens.

12. The waveguide lens according to claim 2, wherein,
a refractive index of the waveguide substrate is greater than or equal to 1.5 and less than or equal to 4; and/or
a thickness of the waveguide substrate is greater than or equal to 0.2 mm and less than or equal to 2 mm.

13. The waveguide lens according to claim 2, wherein at least one of the first glass cover plate and the second glass cover plate is a myopia lens.

14. The waveguide lens according to claim 3, wherein,
a refractive index of the waveguide substrate is greater than or equal to 1.5 and less than or equal to 4; and/or
a thickness of the waveguide substrate is greater than or equal to 0.2 mm and less than or equal to 2 mm.

15. The waveguide lens according to claim 3, wherein at least one of the first glass cover plate and the second glass cover plate is a myopia lens.

16. The waveguide lens according to claim 6, wherein,
a refractive index of the waveguide substrate is greater than or equal to 1.5 and less than or equal to 4; and/or
a thickness of the waveguide substrate is greater than or equal to 0.2 mm and less than or equal to 2 mm.

17. The waveguide lens according to claim 6, wherein at least one of the first glass cover plate and the second glass cover plate is a myopia lens.

18. The waveguide lens according to claim 3, wherein the first bonding layer is made of one of an ultraviolet curing optical cement or a solid optical cement, and the second bonding layer is made of one of the ultraviolet curing optical cement or the solid optical cement.

19. The waveguide lens according to claim 1, wherein the low-refractive-index transparent layer is made of a low-refractive-index optically transparent bonding inorganic material, a viscosity of the low-refractive-index transparent layer is greater than or equal to 2000 mPa·s.

20. The waveguide lens according to claim 1, wherein the diffraction grating at least comprises a coupling-in grating for coupling in rays and a coupling-out grating for coupling out rays.
